(19) United States
(12) Patent Application Publication
(10) Pub. No.: US 2009/0105320 A1
(43) Pub. Date: Apr. 23, 2009

(54) Biodal Compositions Containing 1,2-Benzisothiazolin-3-One And 1,2-Dibromo-2,4-Dicyanobutane

(76) Inventors: Uwe Falk, Bruchkobel (DE); Michael Marcus Walter, Liederbach (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 12/225,028

(22) PCT Filed: Feb. 26, 2007
(86) PCT No.: PCT/EP2007/001629

§ 371 Date: Oct. 3, 2008

(30) Foreign Application Priority Data
Mar. 9, 2006 (DE) 10 2006 010 941.4

(51) Int. Cl. A01N 43/80; C09D 5/00

(52) U.S. Cl. 514/373; 106/18.33; 523/122; 510/382

(57) ABSTRACT

This invention relates to biocidal compositions in the form of solutions, containing a) 1,2-benzisothiazolin-3-one (formula I) and/or a salt thereof, preferably its alkali metal or ammonium salt, in particular its lithium, sodium or potassium salt; b) 1,2-dibromo-2,4-dicyanobutane (formula (II)); c) at least one solvent which is a mixture of a compound of the formula III with glycerol (formula (III)); wherein R¹ and R² are each independently hydrogen or a linear or branched, saturated or unsaturated alkyl group having 1 to 8 carbon atoms, (O-A) is an alkoxy group selected from an ethylenoxy group (EO), propylenoxy group (PO), butylenoxy group and/or phenylethoxy group, x represents a number ranging from 1 to 15 and y represents a number ranging from 0 to 10.

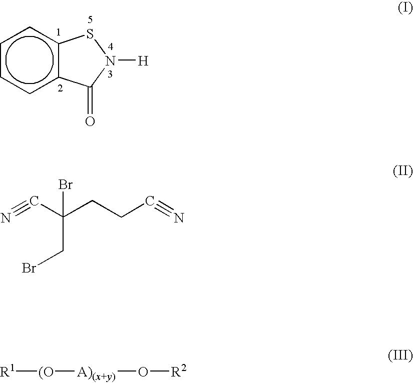

The present invention relates to biocidal compositions in the form of solutions, comprising 1,2-benzisothiazolin-3-one, 1,2-dibromo-2,4-dicyanobutane and at least one solvent selected from the group of the glycols, polyglycols and their ethers, and their use as preservatives.

Biocides are employed in many fields of application in order to control or prevent the growth of microorganisms and thus to ensure the preservation of products and materials. Important fields of application are the preservation of acrylic paints or water-based adhesives, or the treatment of surfaces. For the preservatives to have a broad spectrum of action against such a variety of microorganisms such as bacteria, fungi, molds and algae, products which are combinations of several biocidal active substances are employed in most cases.

Biocidal compositions of 1,2-benzisothiazolin-3-one and 1,2-dibromo-2,4-dicyanobutane are employed widely as antibacterial and antifungal active substances, for example in the construction industry, the textile industry, the leather industry, the paper industry, the electrical industry and the food industry, but also in cosmetics and agriculture. Equally, the two active substances are preferably employed in paints and adhesives, water-in-oil emulsions and lubricants.

EP-A-98410 describes the synergistic effect of 1,2-benzisothiazolin-3-one and 1,2-dibromo-2,4-dicyanobutane on microorganisms and claims their use in a wide range of formulations, and mentions advantageous concentrations of the two active substances for different applications. The biocidal active substances can be incorporated into the formulation or preparation sequentially or jointly, either in solid form or in the form of a dispersion.

JP-A-6 119 704 describes biocidal compositions of the active substances 1,2-benzisothiazolin-3-one (BIT) and 1,2-dibromo-2,4-dicyanobutane in the form of dispersions in xylene or in the form of flowable powders.

Dispersions of biocidal compositions are liable to phase separation or clumping upon temperature fluctuations and prolonged storage; they, like solids, are difficult to incorporate homogenously into formulations. Advantageous for the user are solutions of low viscosity which are pumpable and sprayable, user friendly and well tolerated in ecological and toxicological terms.

GB-A-1 191 253 and GB-A-1 330 531 disclose BIT solutions in a solvent mixture of water and amines. Amines have a strong odor, are highly volatile and unsuitable for a variety of applications, for example in the food industry.

1,2-Benzisothiazolin-3-one is sparingly soluble in water. U.S. Pat. No. 4,188,376 describes that 1,2-benzisothiazolin-3-one can be dissolved in a propylene glycol/water mixture or a diethylene glycol/water mixture, where these solutions are only stable with an active substance content of below 5% by weight. Higher concentrated solutions are liable to precipitation. However, commercially employed biocidal compositions which are advantageous are those with active substance concentrations of above 5%.

1,2-dibromo-2,4-dicyanobutane is sparingly soluble in solvents such as glycerol or 2-ethylhexanol, readily soluble in other frequently used solvents such as dimethyl sulfoxide or N-methylpyrrolidone, but chemically unstable.

The problem to be solved was therefore to provide solutions of 1,2-benzisothiazolin-3-one and 1,2-dibromo-2,4-dicyanobutane which are physically and chemically stable. In addition, the solutions should be well tolerated ecologically and toxicologically, have boiling points above 100° C. and, in particular, should be capable of being readily incorporated into aqueous formulations.

Surprisingly, it has been found that this problem is solved by using a solvent selected from the group of the glycols, polyglycols and their ethers.

The invention therefore relates to biocidal compositions in the form of solutions, comprising
a) 1,2-benzisothiazolin-3-one

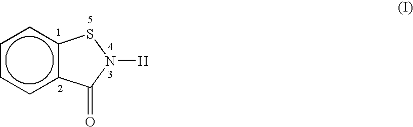

and/or a salt thereof, preferably its alkali metal or ammonium salt, in particular its lithium, sodium or potassium salt,
b) 1,2-dibromo-2,4-dicyanobutane

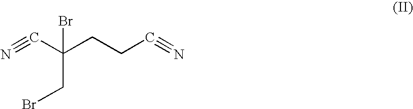

c) at least one solvent of the formula III

R¹—(O-A)_{(x+y)}-O—R² (III)

in which
R¹ and R² independently of one another are hydrogen or a straight-chain or branched, saturated or unsaturated alkyl group having 1 to 8 carbon atoms,
(O-A) is an alkoxy group selected from among ethylenoxy group (EO), propylenoxy group (PO), butylenoxy group and/or phenylethoxy group,
x is a number from 1 to 15 and
y is a number from 0 to 10.

In one embodiment, (O-A)_{(x+y)} is a homogenous alkoxy group comprising (x+y)=1 to 25 alkoxy units. In a further embodiment, (O-A)_{(x+y)} is a mixed alkoxy group of the formula —(O-A¹)ₓ-(O-A²)_{y}- which can be arranged randomly or blockwise and in which x and y have the abovementioned meanings. In this case, (O-A¹) is an ethylenoxy unit and (O-A²) is a propylenoxy unit, a butylenoxy unit or a phenylethoxy unit. If more than one unit (O-A²) is present, then (O-A²) can uniformly be propylenoxy units, butylenoxy units or phenylethoxy units, or mixtures of these.

A phenylethoxy group is taken to mean, in the present context, the structural unit formed by the addition of phenyloxiran.

R¹ and R² preferably independently of one another be alkyl groups having 1 to 4 carbon atoms, preferably methyl.

x preferably is a number from 1 to 10, in particular from 2 to 8.

y preferably is a number from 1 to 5.

In a preferred embodiment of the invention, R¹ is hydrogen and R² is a straight-chain or branched alkyl group having 1 to 8 carbon atoms, x is a number between 2 and 12 and y is 0.

In a further preferred embodiment of the invention, R¹ is hydrogen, R² is n-butyl, x is a number from 2 to 6, preferably 3 to 6, and y is the number 0.

In a further preferred embodiment of the invention, R¹ is hydrogen, R² is methyl, x is a number from 2 to 12, preferably a number from 6 to 8, and y is zero.

In a further preferred embodiment of the invention, R¹ and R² are hydrogen.

In a further preferred embodiment of the invention, R¹ and R² are hydrogen, (O-A) is an ethylenoxy group (EO), x is a number from 1 to 15, preferably 2 to 12, especially preferably 3 to 10, and y is zero.

Preferred solvents are ethylene glycol, diethylene glycol, triethylene glycol, tetraethylene glycol, pentaethylene glycol, hexaethylene glycol, heptaethylene glycol, octaethylene glycol, propylene glycol, dipropylene glycol, tripropylene glycol, polypropylene glycol, ethylene propylene glycol, polyethylene polypropylene glycol, ethyl glycol, propyl glycol, isopropyl glycol, n-butyl glycol, i-butyl glycol, t-butyl glycol, methyl diglycol, methyl polyglycol, ethyl diglycol, propyl diglycol, butyl diglycol, ethyl triglycol, propyl triglycol, butyl triglycol, butyl polyglycol, propylene glycol monoethyl ether, propylene glycol mono-n-propyl ether, propylene glycol n-butyl ether, methyldipropylene glycol, monoethylene glycol dimethyl ether (monoglyme), diethylene glycol dimethyl ether (diglyme), triethylene glycol dimethyl ether (triglyme), triethylene glycol diethyl ether, tetraethylene glycol dimethyl ether (tetraglyme), propylene glycol phenyl ether, polyethylene glycol dibutyl ether; polyethylene glycol diallyl ether; polyethylene glycol allylmethyl ether; polyalkylene glycol allylmethyl ether.

The invention furthermore relates to a process for the preparation of a solution, comprising 1,2-benzisothiazolin-3-one of the formula I and 1,2-dibromo-2,4-dicyanobutane of the formula II by dissolving the two biocidal active substances in a solvent of the formula III.

The invention furthermore relates to the use of a composition in the form of solutions, comprising 1,2-benzisothiazolin-3-one of the formula I, 1,2-dibromo-2,4-dicyanobutane of the formula II and at least one solvent of the formula II, as preservative.

The invention preferably relates to biocidal compositions in the form of solutions, comprising 1,2-benzisothiazolin-3-one of the formula I or its salt in amounts of greater than 1% by weight, preferably in the range of from 1.5% by weight to 30% by weight, especially preferably in the range of from 5% by weight to 10% by weight, and 1,2-dibromo-2,4-dicyanobutane of the formula II in amounts of greater than 1% by weight, preferably in the range of from 1.5% by weight to 40% by weight, especially preferably in the range of from 2% by weight to 30% by weight, very especially preferably 3 to 10% by weight. All percentages are percent by weight, in each case based on the total weight of the solution.

The invention furthermore preferably relates to biocidal compositions in the form of solutions, comprising 1,2-benzisothiazolin-3-one of the formula I or its salt and 1,2-dibromo-2,4-dicyanobutane of the formula II, where the weight ratios of 1,2-benzisothiazolin-3-one to 1,2-dibromo-2,4-dicyanobutane are in the range of from 1:10 to 10:1, preferably 1:5 to 5:1, especially preferably in the range of from 3:1 to 1:1.

The compositions according to the invention may comprise further biocidal active substances which are capable of destroying microorganisms such as bacteria, algae or fungi.

Also suitable are further isothiazolines of the formula VI a or VI b

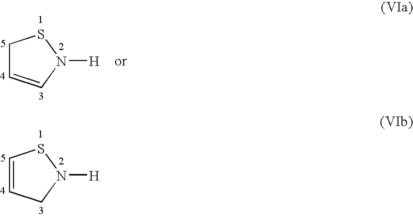

and their derivatives which can have attached to them substituents in positions 2, 3, 4 and/or 5. Such substituents can be, for example, straight-chain, branched or cyclic hydrocarbon groups, halogen atoms or carbonyl groups. Preferred hydrocarbon groups are C₁- to C₁₂-alkyl groups, phenyl groups and fused aromatic systems.

Further preferred derivatives of isothiazoline are isothiazolinones of the formula VII

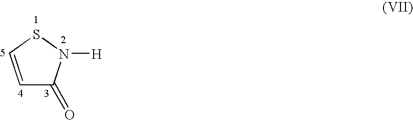

which can have attached to them substituents like the above-described isothiazolines.

Biocidally active isothiazolines are, for example, unhalogenated isothiazolines. Suitable unhalogenated isothiazolines are, for example, 2-methyl-3-isothiazoline, 2-methyl-4-isothiazolin-3-one, 2-ethyl-3-isothiazoline, 2-propyl-3-isothiazoline, 2-isopropyl-3-isothiazoline, 2-butyl-3-isothiazoline (where butyl can be n-butyl, iso-butyl or tert-butyl), 2-n-octyl-3-isothiazoline.

Further biocidally active isothiazolines are, for example, halogenated isothiazolines. Suitable halogenated isothiazolines are, for example, 5-chloro-2-methyl-3-isothiazoline, 5-chloro-2-methyl-4-isothiazolin-3-one or 4,5-dichloro-2-(n-octyl)-4-isothiazolin-3-one.

Further preferred biocidal active substances are

triazines, for example 1,3,5-tris(2-hydroxyethyl)hexahydro-S-triazine, 1,5-trimethyl-[2H,4H,6H]-hexahydro-1,3,5-S-triazine, methylene-bis-morpholine, oxazolidine, 3-iodo-2-propynyl butylcarbamate, 2-bromo-2-nitropropanediol, glutaraldehyde, glutardialdehyde, sodium 2-pyridinethiol 1-oxide, p-hydroxybenzoic acid alkyl esters, tris(hydroxymethyl)nitromethane, dimethyloldimethylhydantoin, 1,6-dihydroxy-2,5-dioxahexane; 3-(3,4-dichlorophenyl)-1,1-dimethylurea (diuron); N-cyclopropyl-N′-(1,1-dimethylethyl)-6-(methylthio)-1,3,5-triazine-2,4-diamine;
methyl benzimidazol-2-ylcarbamate (carbendazim); N-(1,1-dimethylethyl)-N′-ethyl-6-(methylthio)-1,3,5-triazine-2,4-diamine (terbutryn); 4-chloro-3,5-dimethylphenol; 2,4-dichloro-3,5-dimethylphenol; 2-benzyl-4-chlorophenol; 2,2′-dihydroxy-5,5′-dichlorodiphenylmethane; p-tert-amylphenol; o-phenylphenol; sodium o-phenylphenol; p-chloro-m-cresol; 2-(thiocyanomethylthio)benzothiazole;
3,4,4′-trichlorocarbanilide; zinc 1-hydroxy-2-pyridinethione; 1-(4-chlorophenyl)-4,4-dimethyl-3-(1H-1,2,4-triazol-1-ylmethyl)pentan-3-ol (tebuconazole), 1-[2-(2,4-dichlorophenyl)-4-propyl-1,3-dioxolan-2-ylmethyl)-1H-1,2,4-triazole (propiconazole), 3-iodo-2-propynyl butylcarbamate, 2-bromo-2-nitropropanediol, formaldehyde; urea; glyoxal; 2,2′-dithiobis(pyridine N-oxide),
3,4,4-trimethyloxazolidine, 4,4-dimethyloxazolidine, potassium N-hydroxymethyl-N-methyldithiocarbamate, adamantan, N-trichloromethylthiophthalimide,
2,4,5,6-tetrachloroisophthalonitrile, 2,4,5-trichlorophenol, dehydroacetic acid, copper naphthenate, copper octoate, tributyltin oxide, zinc naphthenate, copper 8-quinolate.

Furthermore suitable are biocides from the group of the quaternary ammonium compounds, preferably alkyldimethylammonium chlorides such as, for example, cocodimethylammonium chloride, dialkyldimethylammonium chlorides such as, for example, dicocodimethylammonium chloride, alkyldimethylbenzylammonium chlorides such as, for example, C_{12/14}-dimethylbenzylammonium chloride or cocodimethyldichlorobenzylammonium chloride.

The preparation of the biocidal composition, in the form of a solution, according to the invention can be accomplished in different ways. The active substance 1,2-benzisothiazolin-3-one can be dissolved, with stirring, in a solvent of the formula III and this solution can be added to a solution which contains 1,2-dibromo-2,4-dicyanobutane and a solvent of the formula II. Likewise, it is possible to dissolve solid 1,2-benzisothiazolin-3-one in a solution of 1,2-dibromo-2,4-dicyanobutane and a solvent of the formula III.

The preparation of the biocidal composition, in the form of a solution, according to the invention is preferably accomplished in such a way that the 1,2-benzisothiazolin-3-one is added to the solvent and dissolved with stirring. Thereafter, the 1,2-dibromo-2,4-dicyanobutane is added and dissolved with stirring. The dissolution process can be accelerated by warming gently.

The invention especially preferably relates to biocidal compositions in the form of solutions, comprising 1 to 10 percent by weight of 1,2-benzisothiazolin-3-one, 1 to 10 percent by weight of 1,2-dibromo-2,4-dicyanobutane and, as solvent, polyethylene glycol with 7 glycol units.

The invention furthermore especially preferably relates to biocidal compositions in the form of solutions, comprising 3 to 10 percent by weight of 1,2-benzisothiazolin-3-one, 2 to 8 percent by weight of 1,2-dibromo-2,4-dicyanobutane and, as solvent, diethylene glycol.

The invention furthermore especially preferably relates to biocidal compositions in the form of solutions, comprising 1 to 10 percent by weight of 1,2-benzisothiazolin-3-one, 1 to 10 percent by weight of 1,2-dibromo-2,4-dicyanobutane and, as solvent, butyl polyglycol with 2 to 6 glycol units.

In a preferred embodiment, the biocidal compositions according to the invention can comprise, in addition to the solvents of the formula (III), up to 60% by weight, preferably up to 40% by weight, of further solvents. Such further solvents are selected from the group consisting of
the alcohols, for example methanol, ethanol, n-propanol, i-propanol, n-butanol, i-butanol, t-butanol, n-pentanol, n-hexanol, 2-methoxyethanol, 2-butoxyethanol, 2-(2-butoxyethoxyl)ethanol, phenoxyethanol, 2-(2-butoxyethoxyl)ethanol, 3-methoxybutanol, 1-methoxy-2-propanol, sec-butyl alcohol, tert-butyl alcohol, iso-butyl alcohol, 2-ethylhexanol, 2-propoxyethanol, benzyl alcohol, phenethyl alcohol, 1,2,6-hexanetriol,
the alkanes, for example pentane, hexane, heptane,
the chlorinated alkanes, for example methylene chloride, ethylene dichloride;
the aromatics, for example benzene, toluene, xylene;
the nitriles, for example acetonitrile;
the amides, for example dimethylformamide, N,N-dimethylacetamide, hexamethylphosphoric amide;
the ketones, for example acetone, ethyl methyl ketone, methyl isobutyl ketone, methyl isobutyl ketone, methyl amyl ketone, methyl isoamyl ketone, 2-butanone,
the ethers, for example isopropyl ether,
the acetates, for example ethyl acetate, propyl acetate, i-propyl acetate, butyl acetate, i-butyl acetate, 2-methoxyethyl acetate, 1-methoxy-2-propyl acetate, ethylene glycol diacetate,
the lactates, for example methyl lactate, ethyl lactate,
the phosphates, for example trihexyl(tetradecyl)phosphonium hexafluorophosphate, trihexyl(tetradecyl)phosphonium tetrafluorophosphate,
the amines, for example monoethanolamine, diethanolamine, triethanolamine,
The polyols are, for example, polyhydric alcohols of the formula IV

R³(OH)_{y} IV

in which
R³ is a hydrocarbon group with 3 to 40, preferably up to 20, carbon atoms, and
y is an integer from 3 to 40, preferably up to 20,
   and in which each carbon atom present in R³ bears not more than one, or no, OH group,
   in particular glycerol, trimethylolethane, trimethylolpropane, polyglycerol or mixtures of all of these,
   and furthermore tetrahydrofuran, 1,4-dioxane, dimethyl sulfoxide, diethyl carbonate, propylene carbonate, pyridine, picoline, lutidine, collidine, cyclohexanone and/or water, and 2,2,4-trimethyl-1,3-pentanediol monoisobutyrate (Texanol ester).

In a further, especially preferred embodiment, the solvent for the biocides a) and b) is a mixture of a compound of the formula III with glycerol in the weight ratio 5:1 to 1:5. In formula III, R¹ and R² preferably are hydrogen, x preferably is a number from 4 to 14, in particular 8, and y preferably is zero.

The compositions according to invention are usually employed in such weight amounts that from 0.0001% by weight to 5% by weight, preferably 0.0002% by weight to 3% by weight, especially preferably 0.0005% by weight to 1% by weight, of the two biocidal active substances together are employed, based on the substrate to be treated or the end product which has been treated.

If appropriate, the biocidal compositions according to the invention can comprise emulsifiers or dispersants.

Suitable dispersants and emulsifier are addition products of 2 to 30 mol of ethylene oxide and/or up to 5 mol of propylene oxide with straight-chain fatty alcohols having 8 to 22 carbon atoms, with fatty acids having 12 to 22 carbon atoms and with alkylphenols having 8 to 15 carbon atoms in the alkyl group; C₁₂-C₁₈-fatty acid mono- and diesters of addition products of 1 to 30 mol of ethylene oxide with glycerol; glycerol mono- and diesters and sorbitan mono- and diesters of saturated and unsaturated fatty acids having 6 to 22 carbon atoms and their ethylene oxide addition products; addition products of 15 to 60 mol of ethylene oxide with castor oil and/or hydrogenated castor oil; polyol esters, in particular polyglycerol esters such as, for example, polyglycerol polyricinoleate and polyglycerol poly-12-hydroxystearate. Preferred liquid fatty acid esters are PEG-10 polyglyceryl-2 laurate and polyglyceryl-2 sesquiisostearate.

Furthermore suitable are ethoxylated and nonethoxylated mono-, di- or trialkylphosphoric acid esters and alkylarylphosphoric acid esters, for example isotridecylphosphoric acid esters and their salts, tri-sec-butylphenolphosphoric acid esters and their salts, and tristyrylphenylphosphoric acid esters and their salts.

It is also possible to employ cationic emulsifiers such as mono-, di- and trialkylquats and their polymeric derivatives.

Mixtures of compounds of two or more of these classes of substances are also suitable. The addition products of ethylene oxide and/or propylene oxide with fatty alcohols, fatty acids, alkylphenols, glycerol monoesters and diesters and sorbitan monoesters and diesters of fatty acids or with castor oil are known commercially available products. These take the form of homolog mixtures whose mean degree of alkoxylation corresponds to the ratio between the amounts of the substances ethylene oxide and/or propylene oxide and of substrate, with which amounts the addition reaction is carried out.

The biocidal compositions according to the invention can comprise from 0.1 to 40% by weight, preferably 1 to 30% by weight, especially preferably 3 to 20% by weight, of one or more emulsifiers or dispersants, based on the finished biocidal compositions.

The biocidal compositions according to the invention can additionally comprise surfactants, thickeners, antigelling agents, solubilizers, agents which impart protection against low temperatures, antifoaming agents, buffers, wetting agents, complexing agents, sequestrants, electrolytes, adjusting agents, odoriferous substances and colorants.

In a further embodiment, the compositions according to the invention can comprise anionic surfactants.

Preferred anionic surfactants are straight-chain or branched alkyl sulfates, alkylsulfonates, alkyl carboxylates, alkyl phosphates, alkyl sulfosuccinates and alkyl taurates, alkyl ester sulfonates, arylalkylsulfonates and alkyl ether sulfates.

Alkyl sulfates are water-soluble salts or acids of the formula ROSO₃M in which R preferably is a C₁₀-C₂₄-hydrocarbon radical, especially preferably an alkyl or hydroxyalkyl radical having 10 to 20 carbon atoms and particularly preferably a C₁₂-C₁₈-alkyl or -hydroxyalkyl radical. M is hydrogen or a cation, preferably an alkali metal cation (for example sodium, potassium, lithium) or ammonium or substituted ammonium, for example a methyl-, dimethyl- and trimethylammonium cation or a quaternary ammonium cation such as tetramethylammonium and dimethylpiperidinium cation and quaternary ammonium cations derived from alkylamines such as ethylamine, diethylamine, triethylamine and their mixtures.

The alkyl ether sulfates are water-soluble salts or acids of the formula RO(A)ₘSO₃M in which R preferably is an unsubstituted C₁₀-C₂₄-alkyl or -hydroxyalkyl radical, especially preferably a C₁₂-C₂₀-alkyl or -hydroxyalkyl radical and particularly preferably a C₁₂-C₁₈-alkyl or -hydroxyalkyl radical. A is an ethoxy or propoxy unit, m is a number greater than 0, typically between 0.5 and 6, especially preferably between 0.5 and 3, and M is a hydrogen atom or a cation, preferably a metal cation (for example sodium, potassium, lithium, calcium, magnesium), ammonium or a substituted ammonium cation. Examples of substituted ammonium cations are methyl-, dimethyl-, trimethylammonium and quaternary ammonium cations such as tetramethylammonium and dimethylpiperidinium cations, and those which are derived from alkylamines such as ethylamine, diethylamine, triethylamine or mixtures of these. Examples which may be mentioned are C₁₂-C₁₈-alkylpolyethoxylate (1.0)sulfate, C₁₂-C₁₈-alkylpolyethoxylate (2.25)sulfate, C₁₂-C₁₈-alkylpolyethoxylate (3.0)sulfate, C₁₂-C₁₈-alkylpolyethoxylate (4.0)sulfate, the cation being sodium or potassium.

Alkylsulfonates which are also suitable are those with straight-chain or branched C₆-C₂₂-alkyl chains, for example primary paraffin sulfonates, secondary paraffin sulfonates, alkylarylsulfonates, for example straight-chain alkylbenzenesulfonates with C₅-C₂₀-alkyl chains, alkylnaphthalenesulfonates, condensates of naphthalenesulfonate and formaldehyde, lignosulfonate, alkyl ester sulfonates, i.e. sulfonated straight-chain esters of C₈-C₂₀-carboxylic acids (i.e. fatty acids), C₈-C₂₄-olefinsulfonates, sulfonated polycarboxylic acids, prepared by sulfonating the pyrolysates of alkaline earth metal citrates.

Further suitable anionic surfactants are selected among alkylglycerol sulfates, fatty acylglycerol sulfates, oleylglycerol sulfates, alkylphenol ether sulfates, alkyl phosphates, alkyl ether phosphates, isethionates such as acylisethionates, N-acyltaurides, alkylsuccinamates, sulfosuccinates, in particular di-nonyl or di-octyl sulfosuccinates, monoesters of the sulfosuccinates (especially saturated and unsaturated C₁₂-C₁₈-monoesters) and diesters of the sulfosuccinates (especially saturated and unsaturated C₁₂-C₁₈-diesters), acyl sarcosinates, sulfates of alkylpolysaccharides such as sulfates of alkylpolyglycosides, branched primary alkyl sulfates and alkyl polyethoxycarboxylates, such as those of the formula RO(CH₂CH₂O)ₖCH₂COO⁻M⁺ where R is a C₈-C₂₂-alkyl group, k is a number from 0 to 10 and M is a soluble, salt-forming cation.

Nonionic surfactants which are preferably suitable are fatty alcohol ethoxylates (alkylpolyethylene glycols), alkylphenol polyethylene glycols, alkylmercaptan polyethylene glycols, fatty amine ethoxylates (alkylaminopolyethylene glycols), fatty acid ethoxylates (acylpolyethylene glycols), polypropylene glycol ethoxylates (for example Pluronics®), fatty acid alkylolamides (fatty acid amide polyethylene glycols), N-alkyl- and N-alkoxypolyhydroxy fatty acid amides, alkylpolysaccharides, sucrose esters, sorbitol esters and polyglycol ethers.

Suitable amphoteric surfactants are preferably amphoacetates, especially preferably monocarboxylates and dicarboxylates such as cocoamphocarboxypropionate, cocoamidocarboxypropionic acid, cocoamphocarboxyglycinate (also referred to as cocoamphodiacetate) and cocoamphoacetate.

Examples of cationic surfactants which are suitable are di(C₁₀-C₂₄)-alkyldimethylammonium chloride or bromide, preferably di(C₁₂-C₁₈)-alkyldimethylammonium chloride or bromide; (C₁₀-C₂₄)-alkyldimethylethylammonium chloride or bromide; (C₁₀-C₂₄)-alkyltrimethylammonium chloride or bromide, preferably cetyltrimethylammonium chloride or bromide, and (C₂₀-C₂₂)-alkyltrimethylammonium chloride or bromide; (C₁₀-C₂₄)-alkyldimethylbenzylammonium chloride or bromide, preferably (C₁₂-C₁₈)-alkyldimethylbenzylammonium chloride; N—(C₁₀-C₁₈)-alkylpyridinium chloride or bromide, preferably N—(C₁₂-C₁₆)-alkylpyridinium chloride or bromide; N—(C₁₀-C₁₈)-alkylisoquinolinium chloride, bromide or monoalkyl sulfate; N—(C₁₂-C₁₈)-alkylpolyoylaminoformylmethylpyridinium chloride; N—(C₁₂-C₁₈)-alkyl-N-methylmorpholinium chloride, bromide or monoalkyl sulfate; N—(C₁₂-C₁₈)-alkyl-N-ethylmorpholinium chloride, bromide or monoalkyl sulfate; (C₁₆-C₁₈)-alkylpentaoxethylammonium chloride; diisobutylphenoxyethoxyethyldimethylbenzylammonium chloride; salts of N,N-diethylaminoethylstearylamide and -oleylamide with hydrochloric acid, acetic acid, lactic acid, citric acid, phosphoric acid; N-acylaminoethyl-N,N-diethyl-N-methyl-ammonium chloride, bromide or monoalkyl sulfate and N-acylaminoethyl-N,N-diethyl-N-benzylammonium chloride, bromide or monoalkyl sulfate, where acyl is preferably stearyl or oleyl.

The biocidal compositions according to the invention can comprise from 0.1 to 40% by weight, preferably 1 to 30% by weight, especially preferably 3 to 20% by weight, of one or more surfactants, based on the finished biocidal compositions.

Thickeners which are preferably employed are carboxymethylcellulose and hydroxyethylcellulose, xanthan gum, guar gum, agar-agar, alginates and tyloses, furthermore high-molecular-weight polyethylene glycol monoesters and diesters of fatty acids, hydrogenated castor oil, salts of long-chain fatty acids, for example sodium, potassium, aluminum, magnesium and titanium stearates, or the sodium and/or potassium salts of behenic acid, but also polyacrylates, polyvinyl alcohol and polyvinylpyrrolidone, and polysaccharides. Also suitable are copolymers based on acryloyldimethyltauric acid, as described in EP-A-1 060 142, EP-A-1 028 129, EP-A-1 116 733.

The thickeners can preferably be employed in the biocidal compositions according to the invention in amounts of from 0.01 to 5% by weight and in particular in amounts of from 0.5 to 2% by weight, based on the finished biocidal compositions.

Suitable solubilizers are sodium toluenesulfonate, sodium cumenesulfonate, sodium xylenesulfonate, alkanephosphonic acids and alkenyldicarbonic acids, and their anhydrides.

The low temperature stabilizers can be all the usual substances which can be employed for this purpose. Examples which may be mentioned are urea, glycerol and propylene glycol.

Hydrogen peroxide can be any inorganic peroxide which releases hydrogen peroxide in aqueous solution, such as, for example, sodium perborate (monohydrate and tetrahydrate) and sodium percarbonate.

Suitable antifoams are fatty acid alkyl ester alkoxylates; organopolysiloxanes such as polydimethylsiloxanes and their mixtures with ultrafine, optionally silanized silica; paraffins; waxes and microcrystalline waxes and their mixtures with silanized silica. Mixtures of a variety of foam inhibitors, for example those of silicone oil, liquid paraffin and/or waxes, are also advantageous.

Suitable buffers are all customary acids and their salts. Phosphate buffers, carbonate buffers and citrate buffers are mentioned by preference.

Wetting agents which can be employed are alcohol ethoxylates/propoxylates.

Furthermore, the compositions according to the invention preferably comprise neutralizing agents and adjusting agents for adjusting the compositions to a viscosity of 100 to 2000 mPas, preferably approximately 600 mPas. Preferred adjusting agents are inorganic salts, especially preferably ammonium salts or metal salts, in particular of halides, oxides, carbonates, hydrogencarbonates, phosphates, sulfates and nitrates, in particular sodium chloride. Preferred neutralizing agents are NaOH and KOH.

The compositions according to the invention can comprise inorganic and organic salts as electrolytes. Suitable substances are the halides, nitrates, phosphates, carbonates, hydrogencarbonates, sulfates, silicates, acetates, oxides, citrates or polyphosphates of alkali metals, alkaline earth metals, metals or ammonium. Examples which are preferably employed are CaCl₂, MgCl₂, LiCl, KCl, NaCl, K₂SO₄, K₂CO₃, MgSO₄, Mg(NO₃)₂, ZnCl₂, ZnO, MgO, ZnSO₄, CuSO₄, Cu(NO₃)₂.

Suitable organic salts are ammonium salts or metal salts, preferably of glycolic acid, lactic acid, citric acid, tartaric acid, mandelic acid, salicylic acid, ascorbic acid, pyruvic acid, fumaric acid, retinoic acid, sulfonic acids, benzoic acid, kojic acid, fruit acid, malic acid, gluconic acid, galacturonic acid. The compositions according to the invention can also comprise mixtures of a variety of salts as electrolyte.

The preparations according to the invention can comprise electrolytes in amounts of from 0.01 to 50% by weight, preferably 0.1 to 20% by weight, especially preferably 0.5 to 10% by weight, based on the biocidal composition.

Examples of suitable sequestrants are sodium tripolyphosphate (STPP), ethylenediaminetetraacetic acid (EDTA), its salts, nitrilotriacetic acid (NTA), polyacrylate, phosphonate, for example 1-hydroxyethane-1,1-diphosphonic acid (HEDP), salts of polyphosphoric acids such as ethylenediaminetetramethylenephosphonic acid (EDTMP) and diethylenetriaminepentamethylenephosphonic acid (DTPMP), oxalic acid, oxalic acid salt, citric acid, zeolite, carbonates and polycarbonates.

Suitable complexing agents are phosphonates, aminophosphonates and aminocarboxylates.

The biocidal compositions according to the invention are preferably employed for the preservation of paints, varnishes, polymer emulsions, cooling lubricants, metal-working auxiliaries, crop protection formulations, construction chemicals, detergents, plastic and adhesives.

Moreover, the biocidal compositions according to the invention can be used as disinfectant, either directly or in dilution.

Moreover, the biocidal compositions according to the invention can be incorporated into coating materials for surfaces. Surfaces which are coated with such coating materials are thereby equipped with biocidal properties.

The abovementioned application rates of the biocidal active substances apply to all the abovementioned applications.

The biocidal compositions preferably have a pH of from 1 to 13, especially preferably 3 to 9, in particular 4 to 8.

### EXAMPLES

The examples which follow are intended to illustrate the invention in greater detail. All percentages are by weight, unless otherwise specified.

TABLE 1
Solubilities of biocidal active substances in different solvents

| | | | Solubility |
|---|---|---|---|
| Example | Active substance | Solvent | [25° C.] |
| 1 (C) | 1,2-Benzisothiazolin-3-one | Diethylene glycol | 7% |
| 2 (C) | 1,2-Benzisothiazolin-3-one | Polyethylene glycol 300 | 8% |
| 3 (C) | 1,2-Benzisothiazolin-3-one | Butyl polyglycol | 10% |
| 4 (C) | 1,2-Benzisothiazolin-3-one | TEGDME | 8% |
| 5 (C) | 1,2-Benzisothiazolin-3-one | Dipropylene glycol | 5% |
| 6 (C) | 1,2-Benzisothiazolin-3-one | Polyglycol M 350 | 9% |
| 7 (C) | 1,2-Benzisothiazolin-3-one | Polyglycol D 21/150 | 4% |
| 8 (C) | 1,2-Benzisothiazolin-3-one | Butyl diglycol | 7% |
| 9 (C) | 1,2-Benzisothiazolin-3-one | Dimethyl sulfoxide | 30% |
| 10 (C) | 1,2-Benzisothiazolin-3-one | N-Methylpyrrolidone | 7% |
| 11 (C) | 1,2-Benzisothiazolin-3-one | 2-Ethylhexanol | insoluble |
| 12 (C) | 1,2-Benzisothiazolin-3-one | Glycerol | insoluble |
| 13 (C) | 1,2-Benzisothiazolin-3-one | Polyethylene glycol 400/glycerol 3:1 | 7% |
| 14 (C) | 1,2-Dibromo-2,4-dicyanobutane | Diethylene glycol | 20% |
| 15 (C) | 1,2-Dibromo-2,4-dicyanobutane | Polyethylene glycol 300 | 35% |
| 16 (C) | 1,2-Dibromo-2,4-dicyanobutane | Butyl polyglycol | 40% |
| 17 (C) | 1,2-Dibromo-2,4-dicyanobutane | TEGDME | 45% |
| 18 (C) | 1,2-Dibromo-2,4-dicyanobutane | Dipropylene glycol | 10% |
| 19 (C) | 1,2-Dibromo-2,4-dicyanobutane | Polyglycol M 350 | 45% |
| 20 (C) | 1,2-Dibromo-2,4-dicyanobutane | Polyglycol D 21/150 | 15% |
| 21 (C) | 1,2-Dibromo-2,4-dicyanobutane | Butyl diglycol | 30% |
| 22 (C) | 1,2-Dibromo-2,4-dicyanobutane | Dimethyl sulfoxide | 45% |
| 23 (C) | 1,2-Dibromo-2,4-dicyanobutane | N-Methylpyrrolidone | 40% |
| 24 (C) | 1,2-Dibromo-2,4-dicyanobutane | 2-Ethylhexanol | insoluble |
| 25 (C) | 1,2-Dibromo-2,4-dicyanobutane | Glycerol | insoluble |
| 26 (C) | 1,2-Dibromo-2,4-dicyanobutane | Polyethylene glycol 400/glycerol 3:1 | 20% |
| 27 | 1,2-Benzisothiazolin-3-one/ | Diethylene glycol | 9% |
| | 1,2-dibromo-2,4-dicyanobutane | | |
| | ratio: 3:1 | | |
| 28 | 1,2-Benzisothiazolin-3-one/ | Polyethylene glycol 300 | 10% |
| | 1,2-dibromo-2,4-dicyanobutane | | |
| | ratio: 3:1 | | |
| 29 | 1,2-Benzisothiazolin-3-one/ | Butyl polyglycol | 15% |
| | 1,2-dibromo-2,4-dicyanobutane | | |
| | ratio: 3:1 | | |
| 30 | 1,2-Benzisothiazolin-3-one/ | 2-Ethylhexanol | insoluble |
| | 1,2-dibromo-2,4-dicyanobutane | | |
| | ratio: 3:1 | | |
| 31 | 1,2-Benzisothiazolin-3-one/ | N-Methylpyrrolidone | 9% |
| | 1,2-dibromo-2,4-dicyanobutane | | |
| | ratio: 3:1 | | |
| 32 | 1,2-Benzisothiazolin-3-one/ | Polyethylene glycol 400/glycerol 3:1 | 10% |
| | 1,2-dibromo-2,4-dicyanobutane | | |
| | ratio: 3:1 | | |
| 33 | 1,2-Benzisothiazolin-3-one/ | Diethylene glycol | 20% |
| | 1,2-dibromo-2,4-dicyanobutane | | |
| | ratio: 1:3 | | |
| 34 | 1,2-Benzisothiazolin-3-one/ | Polyethylene glycol 300 | 20% |
| | 1,2-dibromo-2,4-dicyanobutane | | |
| | ratio: 1:3 | | |
| 35 | 1,2-Benzisothiazolin-3-one/ | Butyl polyglycol | 25% |
| | 1,2-dibromo-2,4-dicyanobutane | | |
| | ratio: 1:3 | | |
| 36 | 1,2-Benzisothiazolin-3-one/ | 2-Ethylhexanol | insoluble |
| | 1,2-dibromo-2,4-dicyanobutane | | |
| | ratio: 1:3 | | |
| 37 | 1,2-Benzisothiazolin-3-one/ | N-Methylpyrrolidone | 20% |
| | 1,2-dibromo-2,4-dicyanobutane | | |
| | ratio: 1:3 | | |
| 38 | 1,2-Benzisothiazolin-3-one/ | Diethylene glycol | 9% |
| | 1,2-dibromo-2,4-dicyanobutane | | |
| | ratio: 10:1 | | |
| 39 | 1,2-Benzisothiazolin-3-one/ | Polyethylene glycol 300 | 9% |
| | 1,2-dibromo-2,4-dicyanobutane | | |
| | ratio: 10:1 | | |
| 40 | 1,2-Benzisothiazolin-3-one/ | Butyl polyglycol | 9% |
| | 1,2-dibromo-2,4-dicyanobutane | | |
| | ratio: 10:1 | | |
| 41 | 1,2-Benzisothiazolin-3-one/ | Diethylene glycol | 30% |
| | 1,2-dibromo-2,4-dicyanobutane | | |
| | ratio: 1:10 | | |
| 42 | 1,2-Benzisothiazolin-3-one/ | Polyethylene glycol 300 | 35% |
| | 1,2-dibromo-2,4-dicyanobutane | | |
| | ratio: 1:10 | | |
| 43 | 1,2-Benzisothiazolin-3-one/ | Butyl polyglycol | 35% |
| | 1,2-dibromo-2,4-dicyanobutane | | |
| | ratio: 1:10 | | |

To determine the solubilities of the active substance(s), 50% by weight of active substance/active substance mixture and 50% by weight of solvent was stirred for 15 minutes at 25° C. If no solution is obtained, in each case 5% by weight of solvent is added, and the mixture is stirred for 15 minutes at 25° C. until a clear solution results.

TABLE 2
Storage stability of biocidal active substances in different solvents at −5° C., +20° C. and +50° C. at 14 days' storage

| | Active substance [amount in % | | Storage stability | Storage stability | Storage stability |
|---|---|---|---|---|---|
| Example | by weight] | Solvent | at −5° C. | at +20° C. | at +50° C. |
| 44 (C) | 1,2-Benzisothiazolin-3-one | Diethylene glycol | clear solution | clear solution | clear solution |
| 45 (C) | 1,2-Benzisothiazolin-3-one | Polyethylene glycol 300 | clear solution | clear solution | clear solution |
| 46 (C) | 1,2-Benzisothiazolin-3-one | Butyl polyglycol | clear solution | clear solution | clear solution |
| 47 (C) | 1,2-Benzisothiazolin-3-one | N-Methylpyrrolidone | clear solution | clear solution | clear solution |
| 48 (C) | 1,2-Benzisothiazolin-3-one | Dimethyl sulfoxide | clear solution | clear solution | clear solution |
| 49 (C) | 1,2-Dibromo-2,4-dicyanobutane | Diethylene glycol | clear, colorless | clear, colorless | clear, colorless |
| | | | solution | solution | solution |
| 50 (C) | 1,2-Dibromo-2,4-dicyanobutane | Polyethylene glycol 300 | clear, colorless | clear, yellowish | clear, yellowish |
| | | | solution | solution | solution |
| 51 (C) | 1,2-Dibromo-2,4-dicyanobutane | Butyl polyglycol | clear, colorless | clear, yellowish | clear, yellowish |
| | | | solution | solution | solution |
| 52 (C) | 1,2-Dibromo-2,4-dicyanobutane | N-Methylpyrrolidone | clear, yellowish | brown solution | black solution |
| | | | solution | | |
| 53 (C) | 1,2-Dibromo-2,4-dicyanobutane | Dimethyl sulfoxide | clear, yellowish | brown solution | black solution |
| | | | solution | | |

TABLE 3
Storage stability of biocidal active substances in different solvents at −5° C., +20° C. and +50° C. at 14 days' storage

| | Active substance [amount in % | | Storage stability | Storage stability | Storage stability |
|---|---|---|---|---|---|
| Example | by weight] | Solvent | at −5° C. | at +20° C. | at +50° C. |
| 54 | 1,2-Benzisothiazolin-3-one/ | Diethylene glycol | clear, light | clear, light | clear, light |
| | 1,2-dibromo-2,4-dicyanobutane | | brown solution | brown solution | brown solution |
| | ratio: 3:1 | | | | |
| 55 | 1,2-Benzisothiazolin-3-one/ | Polyethylene glycol 300 | clear, light | clear, light | clear, light |
| | 1,2-dibromo-2,4-dicyanobutane | | brown solution | brown solution | brown solution |
| | ratio: 3:1 | | | | |
| 56 | 1,2-Benzisothiazolin-3-one/ | Butyl polyglycol | clear, light | clear, light | clear, light |
| | 1,2-dibromo-2,4-dicyanobutane | | brown solution | brown solution | brown solution |
| | ratio: 3:1 | | | | |
| 57 | 1,2-Benzisothiazolin-3-one/ | N-Methylpyrrolidone | clear, light | brown solution | black solution |
| | 1,2-dibromo-2,4-dicyanobutane | | brown solution | | |
| | ratio: 3:1 | | | | |
| 58 | 1,2-Benzisothiazolin-3-one/ | Dimethyl sulfoxide | clear, light | brown solution | black solution |
| | 1,2-dibromo-2,4-dicyanobutane | | brown solution | | |
| | ratio: 3:1 | | | | |
| 59 | 1,2-Benzisothiazolin-3-one/ | Polyethylene | clear, light | clear, light | clear, light |
| | 1,2-dibromo-2,4-dicyanobutane | glycol/glycerol 3:1 | brown solution | brown solution | brown solution |
| | ratio: 3:1 | | | | |

TABLE 4
Storage stability of biocidal active substances in different solvents at
+25° C. and +40° C. after 28 days' storage

| | | | |
|---|---|---|---|
| Example | Storage conditions | BIT [%] | DBDCB [%] |

1,2-Benzisothiazolin-3-one/1,2-dibromo-2,4-dicyanobutane
in diethylene glycol

| | | | |
|---|---|---|---|
| | Starting concentrations | 6.2 | 4.0 |
| 60 | After 4 weeks at 25° C. | 6.1 | 3.9 |
| 61 | After 4 weeks at 40° C. | 6.1 | 3.8 |

1,2-Benzisothiazolin-3-one/1,2-dibromo-2,4-dicyanobutane
in polyethylene glycol 400

| | | | |
|---|---|---|---|
| | Starting concentrations | 6.2 | 4.0 |
| 62 | After 4 weeks at 25° C. | 6.1 | 3.5 |
| 63 | After 4 weeks at 40° C. | 5.2 | 0.5 |

1,2-Benzisothiazolin-3-one/1,2-dibromo-2,4-dicyanobutane
in polyethylene glycol 400/glycerol 3:1

| | | | |
|---|---|---|---|
| | Starting concentrations | 6.0 | 3.9 |
| 64 | After 4 weeks at 25° C. | 6.1 | 3.5 |
| 65 | After 4 weeks at 40° C. | 5.9 | 3.8 |

The comparison of Examples 63 and 65 shows clearly that the combination of the biocides 1,2-benzisothiazolin-3-one and 1,2-dibromo-2,4-dicyanobutane is particularly stable in a mixture of PEG400 and glycerol.

### Formulation Examples

### Example 66

| | |
|---|---|
| Nipacide BIT paste | 10.00 (active substance content 7.5%) |
| 1,2-Dibromo-2,4-dicyanobutane | 4.04% (active substance content 4.0%) |
| Polyglycol 300 | to 100% |
| Appearance of the formulation, | clear, no crystals |
| at 20° C., immediately: | |
| Appearance of the formulation, | clear, no crystals |
| after 14 days' storage at 54° C.: | |
| Appearance of the formulation, | clear, no crystals |
| after 14 days' storage at 5° C.: | |

### Example 67

| | |
|---|---|
| Nipacide BIT paste | 8.50 (active substance content 6.4%) |
| 1,2-Dibromo-2,4-dicyanobutane | 4.04% (active substance content 4.0%) |
| Diethylene glycol | to 100% |
| Appearance of the formulation, | clear, no crystals |
| at 20° C., immediately: | |
| Appearance of the formulation, | clear, no crystals |
| after 14 days' storage at 54° C.: | |
| Appearance of the formulation, | clear, no crystals |
| after 14 days' storage at 5° C.: | |

Chemical name of the commercial products employed:

| | |
|---|---|
| Nipacide BIT: | 1,2-benzisothiazolin-3-one |
| Polyethylene glycol 300: | polyethylene glycol (7 ethylene glycol units) |
| TEGDME | tetraethylene glycol dimethyl ether |
| Polyglycol M350 | polyethylene glycol monomethyl ether |
| Polyglycol D21/150 | ethylene propylene glycol |

1. A biocidal composition in the form of a solution, comprising
a) 1,2-benzisothiazolin-3-one 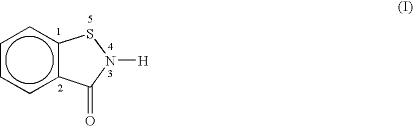
or a salt thereof or a mixture of 1,2-benzisothiazolin-3-one and a salt thereof,
b) 1,2-dibromo-2,4-dicyanobutane 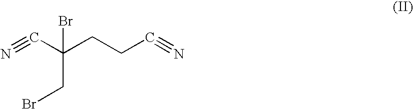
c) at least one solvent which is a mixture of a compound of the formula III with glycerol
R¹—(O-A)_{(x+y)}-O—R² (III)
in which
R¹ and R² independently of one another are hydrogen or a straight-chain or branched, saturated or unsaturated alkyl group having 1 to 8 carbon atoms,
(O-A) is an alkoxy group selected from among ethylenoxy group (EO), propylenoxy group (PO), butylenoxy group and/or phenylethoxy group,
x is a number from 1 to 15 and
y is a number from 0 to 10.

2. The composition as claimed in claim 1, comprising 1,2-benzisothiazolin-3-one of the formula I or its salt in amounts of from 1% by weight to 30% by weight and 1,2-dibromo-2,4-dicyanobutane of the formula II in amounts of 1% by weight to 40% by weight, in each case based on the total weight of the solution.

3. The composition as claimed in claim 1, comprising 1,2-benzisothiazolin-3-one of the formula I or its salt and 1,2-dibromo-2,4-dicyanobutane of the formula II in the weight ratio of 1,2-benzisothiazolin-3-one to 1,2-dibromo-2,4-dicyanobutane in the range of from 1:10 to 10:1.

4. The composition as claimed in claim 1, wherein (O-A)_{(x+y)} is a homogenous alkoxy group comprising (x+y)=1 to 25 alkoxy units.

5. The composition as claimed in claim 1, in which (O-A)_{(x+y)} is a mixed alkoxy group of the formula —(O-A¹)ₓ-(O-A²)_{y}- which can be arranged randomly or blockwise and in which x is a number from 1 to 15 and y is a number from 0 to 10, and (O-A¹) is an ethylenoxy unit and (O-A²) is a propylenoxy unit, a butylenoxy unit or a phenylethoxy unit.

6. The composition as claimed in claim 1, wherein R¹ is an alkyl group having 1 to 4 carbon atoms.

7. The composition as claimed in claim 1, wherein R² is an alkyl group having 1 to 4 carbon atoms.

8. The composition as claimed in claim 1, in which x is a number from 1 to 10.

9. The composition as claimed in claim 1, in which y is a number from 1 to 5.

10. The composition as claimed in claim 1, wherein R¹ is hydrogen and R² is a straight-chain or branched alkyl group having 1 to 8 carbon atoms, x is a number between 2 and 12 and y is 0.

11. The composition as claimed in claim 1, wherein R¹ is hydrogen, R² is n-butyl, x is a number from 2 to 6 and y is the number 0.

12. The composition as claimed in claim 1, wherein R¹ is hydrogen, R² is methyl, x is a number from 2 to 12 and y is zero.

13. The composition as claimed in claim 1, wherein R¹ and R² are hydrogen.

14. The composition as claimed in claim 1, wherein R¹ and R² are hydrogen, (O-A) is an ethylenoxy group (EO), x is a number from 1 to 15, and y is zero.

15. A method of preserving a product composition selected from the group consisting of a paint, a varnish, a polymer emulsion, a cooling lubricant, a metal working auxiliary, a crop protection formulation, a construction chemical, a detergent, a plastic, and an adhesive, said method comprising adding the biocidal composition of claim 1 to said product composition.

16. The composition of claim 8, wherein R¹ and R² are hydrogen

17. The composition of claim 9, wherein R¹ and R² are hydrogen

18. The composition of claim 1, wherein the salt of 1,2-benzisothiazolin-3-one is an alkali metal or an ammonium salt.

19. The composition of claim 1, wherein the salt of 1,2-benzisothiazolin-3-one is a salt selected from the group consisting of lithium, sodium, and potassium.
